(19) United States
(12) Patent Application Publication
(10) Pub. No.: US 2004/0054793 A1
(43) Pub. Date: Mar. 18, 2004

(54) System and method for high performance shared web hosting

(76) Inventor: Richard Coleman, Marietta, GA (US)

Correspondence Address: HOWREY SIMON ARNOLD & WHITE, ATTORNEYS AT LAW, 750 BERING DRIVE, HOUSTON, TX, 77057-2198, US

(21) Appl. No.: 10/286,439

(22) Filed: Nov. 1, 2002

Related U.S. Application Data
(60) Provisional application No. 60/411,214, filed on Sep. 16, 2002.

(51) Int. Cl. G06F 15/16; G06F 15/167

(52) U.S. Cl. 709/229; 709/218; 709/213

(57) ABSTRACT

A system for shared web hosting includes a plurality of web servers coupled to a shared table data structure, wherein the web servers serve web pages to client computer systems. The web servers all couple to a security server that transmits web page requests to the shared table data structure. A website configuration server and virtual host information server couple to the shared table. The virtual host information server couples to a storage device that includes dynamic mapping information. Dynamic mapping information identifies the web server or web servers hosting a web site at any given time. The website configuration server includes static non-changing configuration information for each owner's web site. The non-changing information describes web sites hosted on the web server. The shared table also stores copies of recently accessed non-changing information and dynamic mapping information for web pages.

### CROSS-REFERENCE TO RELATED APPLICATIONS

This application claims the benefit under 35 U.S.C. §119(e) of U.S. provisional application Ser. No. 60/411,214 entitled “SYSTEM AND METHOD FOR HIGH PERFORMANCE SHARED WEB HOSTING” filed on Sep. 16, 2002, by Christopher Bell et al., attorney's docket number 11854.0008.NPUS00, which application is incorporated by reference herein.

### BACKGROUND OF THE INVENTION

1. Field of the Invention

The present invention relates generally to a computer system for high performance shared web hosting, and more particularly to web servers that can host web sites and balance the utilization of a particular web server based on the traffic to the web site.

2. Background of the Invention

The importance to the modern economy of rapid information and data exchange cannot be understated. This explains the exponentially increasing popularity of the Internet. The Internet is a worldwide set of interconnected computer networks that can be used to access a growing amount and variety of information electronically.

One method of accessing information on the Internet 130 is the World Wide Web (WWW or the web). The web is a distributed system, and functions as a client-server based information presentation system. Information that is intended to be accessible over the web is stored in the form of “pages” on general-purpose computers known as “servers” or “web servers” 110 as shown in FIG. 1. In FIG. 1, a network firewall 120 protects the web site pages accessible from the web server from unauthorized tampering and theft. Computer users can access a web page using general-purpose computers, referred to as “clients” (not shown in FIG. 1), by specifying the uniform resource locator (URL) of the page.

When a client specifies a URL, a part of the URL known as the Domain Name is passed to a domain server to be translated to a network address. The network address specifies the Internet Protocol (IP) address of the intended server. The client request is passed to the server having the network address. The server uses the path name in the URL to locate the web page requested by the client. A copy of the web page is then sent to the client for viewing by the user.

In modern web-based computer systems, there currently exists the concept of multiple web servers capable of hosting multiple web sites. Sharing common resources such as web servers is very effective, because it is statistically unlikely that busy periods for one web site will correspond to those of another. However, overutilization of servers may cause either web site service interruptions to current customers or rejection of new customer demands, neither of which is desirable. On the other hand, underutilization is wasteful. It is very likely that the popularity of the hottest web sites will be so great that it takes multiple servers to host them satisfactorily. Thus, it would be highly advantageous to have multiple servers available for hosting highly popular web sites, particularly by taking advantage of resulting multiple web site copies on multiple servers to provide high throughput for user web page requests. However, multiple web servers for a single web site require complex control and synchronization to keep web site content identical on each server. Present day parallel processing systems are expensive and impractical in the price competitive field of web hosting services. Furthermore, during periods when the web site is underutilized, multiple servers for the single web site are wasteful. In such situations a single server can host multiple web sites. Such a “reconfiguration” requires complex control and isolation mechanisms to provide the customer administrator of the web site the illusion of dedicated hosting along with its corresponding functionality. Thus, a simple and cost effective shared web hosting solution is needed that, transparent to client computer systems, permits web servers to host web sites and balance the utilization of a particular web server based on the traffic to the web site.

### BRIEF SUMMARY OF THE INVENTION

The problems noted above are solved in large part by a method and apparatus for shared web hosting including a plurality of web servers coupled to a shared table data structure, wherein the web servers serve web pages to client computer systems. The web servers all couple to a security server that transmits web page requests to the shared table data structure. A website configuration server and virtual host information server couple to the shared table. The virtual host information server couples to a storage device that includes dynamic mapping information. Dynamic mapping information identifies the web server or web servers hosting a web site at any given time. The website configuration server includes static non-changing configuration information for each owner's web site. The non-changing information describes web sites hosted on the web server. The shared table also stores copies of recently accessed non-changing information and dynamic mapping information for web pages.

In the preferred embodiment of the invention, the system further includes one or more hardware devices coupled to the web servers executing firewall software and one or more load balancing devices coupled to the web servers. Preferably, the security server receives web page requests through the Internet from client computer systems. After determining if access to the web site requires authentication, the security server then transmits web page requests to the web servers and the shared table controller. The shared table controller performs a lookup of the shared table to determine website configuration information and virtual host information for the web page request.

### BRIEF DESCRIPTION OF THE DRAWINGS

FIG. 1 shows a hardware system that allows web sites hosted on a web server on the Internet to be accessed using the WWW;

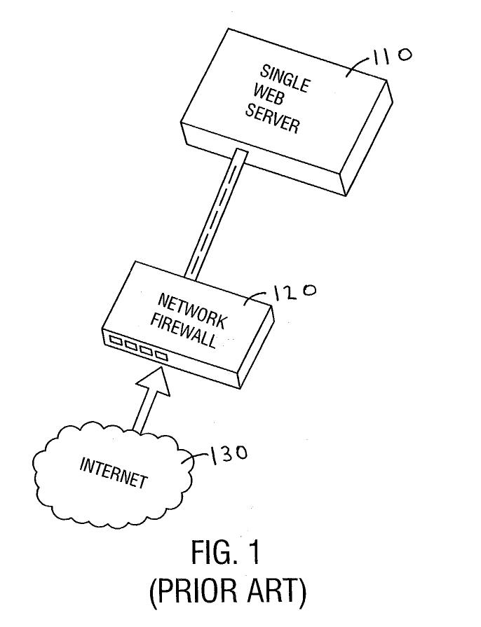

FIG. 2 shows one embodiment of a high availability and high performance system for shared web hosting;

FIG. 3 shows in greater detail one embodiment of various aspects of the embodiment of the invention shown in FIG. 2; and

FIG. 4 shows in greater detail another alternative embodiment of the high availability and high performance shared web hosting system shown in FIG. 2.

### NOTATION AND NOMENCLATURE

Certain terms are used throughout the following description and claims to refer to particular system components and processes. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DESCRIPTION OF ILLUSTRATIVE EMBODIMENTS

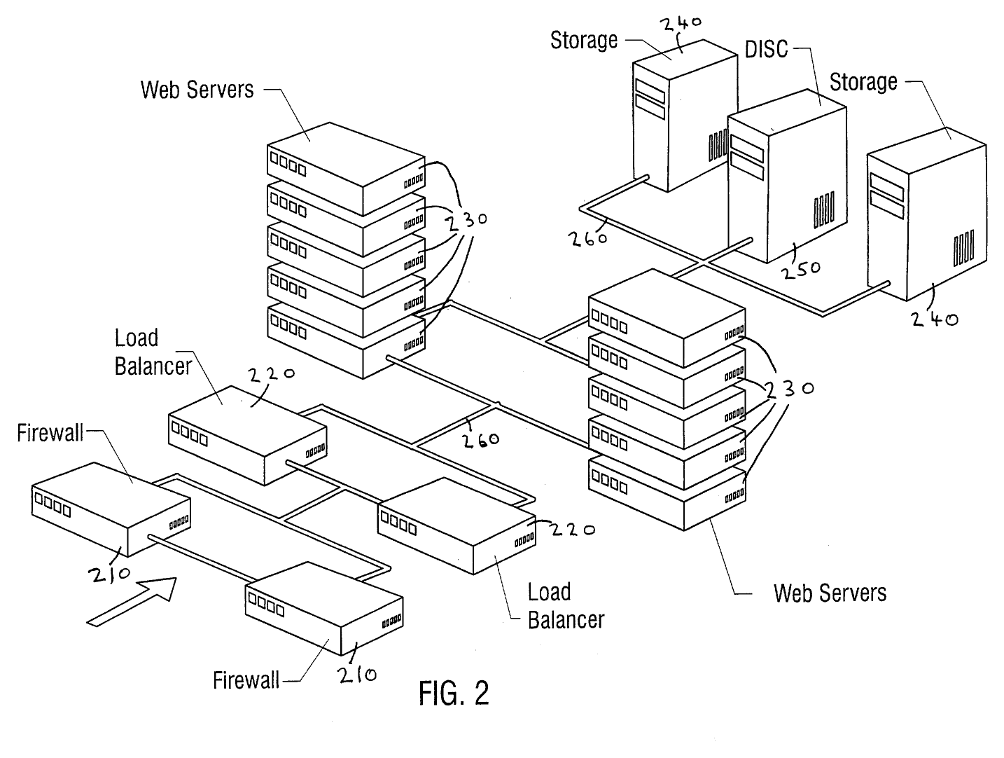

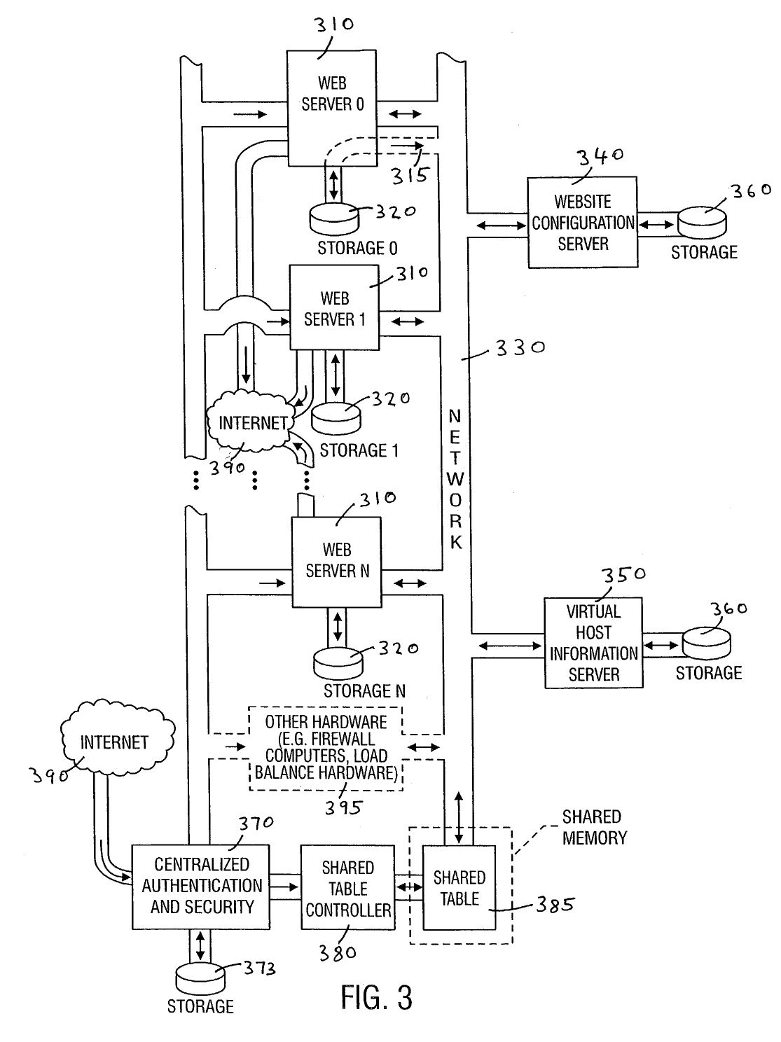

The deficiencies and problems of the prior art described above are solved in large part by a system and method for high performance shared web hosting shown in the preferred embodiment of the invention of FIGS. 2 and 3. In FIG. 2, a high availability scalable web site platform for high performance shared web hosting is shown. Multiple redundant firewalls 210 provide essential security against unauthorized access and modification of computer data and resources. Multiple load balancers 220 route Internet web page traffic to the appropriate web servers 230 and guard against bottlenecks. The parallel processing web server array 230 permits web sites to remain available even if one web server goes down. Network storage units 240 coupled to network 260 deliver web page information directly to the Internet. A compact disc backup system 250 provides redundant backup of the data storage units and prevents data loss.

FIG. 3 shows in greater detail one embodiment of various aspects of the preferred embodiment of the invention shown in FIG. 2. The system consists of multiple web servers Web Server 0, Web Server 1, . . . Web Server N 310 coupled to a Local Area Network (LAN) 330. Storage units Storage 0, Storage 1, . . . Storage N 320 such as hard disk drives standing alone or in an Redundant Array of Inexpensive Disks (RAID) couple to each web server 310. The web servers 310 in combination with storage units provide data for web page requests via the Internet 390. As shown for Web Server 0, the storage unit may have a direct connection to the LAN via a pass through interconnect 315 through the web server. A Website Configuration Server 340 coupled to the LAN includes the static, non-changing configuration information for each owner's web site. Preferably, this may be software code to create text and graphics for read-only web pages or web site owner information for each web site. In one embodiment of the invention, each web server 310 hosting the web site can directly communicate with the Website Configuration Server 340 to receive necessary information. Preferably, a Virtual Host Information (VHI) Server 350 also couples to the LAN 330 and includes dynamic mapping information that identifies the particular web server or servers hosting a web site at any given time.

A request for a web page from a customer user is received from the Internet and routed to a Centralized Authentication and Security (CAS) server 370. The CAS server 370 couples to a dedicated storage system that stores a database of user, server, and password information. A web page request is allowed to pass through the CAS system if it accesses a portion of the web site not requiring any form of authentication, i.e. available to the general public. Other page requests received through the Internet must have the proper level authentication and security to be allowed access to the web server hosting the web site. The authentication mechanism in the preferred embodiment is a user name and password that may be embedded into the web page request. In an alternative embodiment, the CAS may allow the initial web page request to pass through and then generate a screen requesting the user to enter a user name and password. Preferably, Pluggable Authentication Module (PAM) software present in UNIX®, LINUX®, AIX®, HPUX® and similar operating systems will permit the CAS to access networked servers (not shown in FIG. 3) containing password and authentication information in external storage rather than on the CAS server's local storage. Such a “chained” authentication and security system allows another layer of security that prevents unauthorized computer users from “hacking” or breaking into the CAS server. Furthermore, a chained security system allows the web server to quickly serve popular web pages requiring authentication and authorization without the CAS server becoming a performance bottleneck. The centralized security system of the preferred embodiment of the invention allows systemwide authorization and security while reducing the costs of administering and managing security. Preferably, a web page request after passing through the CAS server or receiving authorization from the CAS server transmits the web page request simultaneously to the web servers 310 and a Shared Table Controller 380 described in more detail below.

As discussed above and shown in FIG. 3, preferably, a Virtual Host Information Server 350 coupled to the LAN 330 includes dynamic mapping information that identifies the particular web server or servers hosting a web site at any given time. Virtual Host information Server 350 working in cooperation with the Website Configuration Server 340 affiliates each web site with a particular owner and controls the owners hardware privileges based on the particular hosting configuration selected by the owner. Preferably, hosting configurations permitted by the high performance shared web hosting system shown in FIG. 3 may be dedicated hosting, virtual dedicated hosting, or shared hosting. Dedicated hosting allows a web site exclusive use of one or more web servers as required. Shared hosting permits multiple web sites to be hosted on a single web server. In the preferred embodiment of the invention, virtual dedicated hosting, while giving the web site owner similar outward functionality and capabilities of dedicated hosting, allows multiple web sites to be hosted on a single web server. In virtual dedicated hosting, if a particular web site receives a large number of requests for a period of time, the web site may be hosted by one or more dedicated servers. Additionally, the web site may be hosted on a dedicated server, if the web site owner requests functionality (i.e. reboot the web server because of a software error) that can only be performed on a dedicated server. Virtual Host Information Server also includes information for each customer accessing the web site that specifies the current software state of the web site for the customer.

Preferably as shown in FIG. 3 and discussed above, a web page request is received by the Shared Table Controller 380. The Shared Table Controller 380 may be a dedicated computer system or part of a computer system used for load balancing or as a firewall. Preferably, the Shared Table Controller 380 couples to a Shared Table 385 on a memory device. The Shared Table 385 may be stored on shared memory that is readable and writeable through the LAN 330 by each of the web servers 310, Website Configuration Server 340, Virtual Host Information Server 350 or any other hardware coupled to the LAN 330. The memory device can be Static Random Access Memory (SRAM), Dynamic Random Access Memory (DRAM) or any other read-writeable, high throughput, high bandwidth memory device. After receiving a request for a web page, the Shared Table Controller 380 performs a lookup of the Shared Table 385. If the Website Configuration Information and Virtual Host Information for that web page request are present in the Shared Table 385, the Shared Table Controller 380 immediately routes the page request to the appropriate web server that then serves the web page. If the Virtual Host Information 350 for that web page request is not present in the Shared Table 385, the Shared Table Controller 380 requests owner information about the web page from the Website Configuration Server 340 and generates a new entry for the web page in the Shared Table 385. Next, for the same web page request, the Shared Table Controller 380 accesses the Virtual Host Information Server and determines which web server or servers is presently hosting the web site. This information is also loaded into the Shared Table 385. In one preferred embodiment, in parallel with the lookups of the Website Configuration Server 340 and Virtual Host Information Server 350, the web page request is sent to each web server 310 so that the web server hosting the web site can serve the appropriate page to the customer. In an alternative embodiment, the Shared Table Controller 380 after populating the Shared Table 385 with the website configuration information and virtual host information, then routes the web page request to the correct web server using the recently stored information in the Shared Table 385.

The Shared Table 385 allows the high performance shared web hosting system shown in FIG. 3 to handle a large volume of web requests with low response time and high throughput. The first time a web page is requested by a web site customer that has not been served in the near future, a lookup of the Website Configuration Server 340 and Virtual Host Information Server 350 is performed. If in the near future the same web page is requested, the shared table will contain the information needed to send the request to the appropriate web server that can immediately serve the request. The method of the preferred embodiment of the invention reduces network traffic and allows high performance service of web pages with less hardware.

If the Shared Table 385 is in a “Full” state, i.e. no more slots are available to store website configuration information and virtual host information, the Shared Table Controller 385 performs a “cleaning” procedure. In another alternative embodiment, the cleaning procedure is performed at periodic time intervals such as hourly. “Cleaning” the Shared Table 385 involves determining which entries have not been accessed in the recent past, comparing the Shared Table 385 entry information to the Website Configuration and Virtual Host information and updating the appropriate web server or servers if the comparison generates a difference. Thus, if a web site owner has cancelled his web site hosting contract, the Website Configuration Server 340 would indicate this change and the Shared Table Controller 380 within an hour would expire the Shared Table 385 entries for any web pages that are part of the web site. The Shared Table Controller 380 would no longer direct web page requests to the web server.

Another aspect of the preferred embodiment of the shared table shown in FIG. 3 is the use of a hash lookup function to search the Shared Table 385 for a particular web page entry. Preferably, the Shared Table 385 is a hash table that uses a hash function to search for a web page. Hashing is described in the reference by Thomas H. Cormen, Charles E. Leiserson and Ronald L. Rivest entitled “Introduction to Algorithms” on pages 219-243, MIT Press, 1990, the contents and disclosure of which is incorporated by reference as if fully set forth herein.

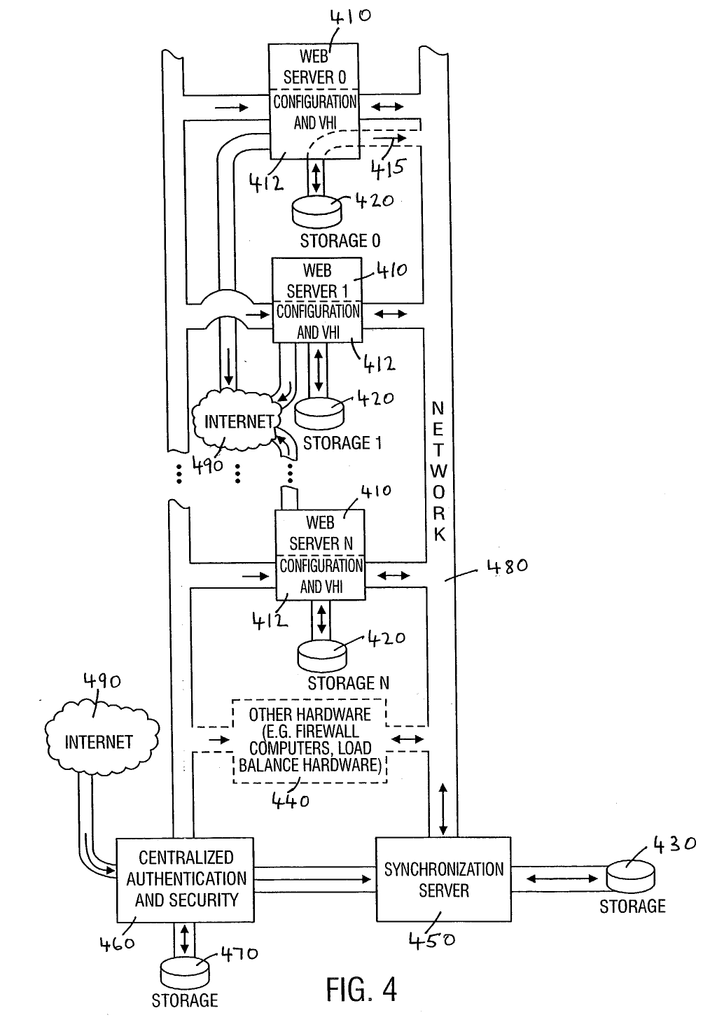

Turning now to FIG. 4, another alternative embodiment of the high performance shared web hosting system is shown. As shown in FIG. 4, in this embodiment each web server 410 includes web site configuration information and virtual host information 412 for each web site hosted by the server. If multiple web servers host a web site, the configuration and virtual host information is replicated across all the web servers and must be frequently synchronized to maintain data coherency. A Synchronization Server 450 couples to each web server 410 through a LAN and stores the last known good state of synchronization. At predefined intervals, the Synchronization Server 450 queries each web server to determine if the configuration and virtual host information have been modified from their last known good state. The Synchronization Server 450 also checks if the file system or registry has been modified. If the Synchronization Server 450 determines that a change has occurred, it notes the appropriate changes and timing of the change. After completing its analysis of each web server and collecting all changes, the Synchronization Server 450 applies each of the changes to its stored last known good state of synchronization in sequential time order and performs contention and conflict resolution. The new good state of synchronization including the updated configuration information, virtual host information, file system and registry is copied to all web servers 410 hosting the web site. The automated system of web server synchronization shown in FIG. 4 replaces manual prior art systems that require the owner of the web site to log into a staging server, make the changes to the web site on that single server and then manually publish that information to all other web servers in the system.

For the preferred embodiment of the invention shown in FIG. 4, because the synchronization of web servers is performed automatically, if one web server hosting a web site has a hardware failure, another web server can quickly and transparently replace it. Thus, if five web servers are hosting a web site and one web server has a hardware issue, another new web server containing no information about the web site can be automatically detected, enabled and configured by the Synchronization Server 450.

The particular embodiments disclosed above are illustrative only, as the invention may be modified and practiced in different but equivalent manners apparent to those skilled in the art having the benefit of the teachings herein. It is therefore evident that the particular embodiments disclosed above may be altered or modified and all such variations are considered within the scope and spirit of the invention. It is intended that the following claims be interpreted to enhance all such variations and modifications.

### References

The following references, to the extent that they provide exemplary procedural or other details supplementary to those set forth herein, are specifically incorporated herein by reference.

1. Apache Software Foundation, “Apache HTTP Server Version 1.3-Using the Apache HTTP Server”, http://httpd.apache.org/docs/, 2002

2. Apache Software Foundation, “Apache HTTP Server Version 2.0 Documentation”, http://httpd.apache.org/docs-2.0/, 2002

What is claimed is:

1. A system for shared web hosting, comprising:
at least two of a first computer means coupled to a shared table, wherein the first computer means serve web pages to clients;
a second computer means coupled to the first computer means, wherein the second computer means transmits web page requests to the shared table;
a third computer means coupled to the shared table;
a fourth computer means coupled to the shared table, wherein the fourth computer means couples to a storage device that includes dynamic mapping information; and
wherein the shared table stores non-changing information and dynamic mapping information for web pages.

2. The system of claim 1, wherein the dynamic mapping information identifies the first computer mean hosting a web site at any given time.

3. The system of claim 2, wherein the first computer mean is a web server.

4. The system of claim 1, wherein the second computer means transmits web page requests to the first computer means.

5. The system of claim 4, wherein the second computer means is a security server.

6. The system of claim 1, wherein the non-changing information for all web sites is stored on a storage device coupled to the third computer means, wherein the non-changing information describes web sites hosted on the first computer mean.

7. The system of claim 6, wherein the third computer means is a website configuration server.

8. The system of claim 1, further comprising:
one or more hardware devices executing firewall software, wherein said hardware devices couple to the first computer means; and
one or more load balancing devices coupled to the first computer means.

9. The system of claim 1, wherein the second computer means receives web page requests through the Internet from clients.

10. The system of claim 10, wherein the fourth computer means is a virtual host information server.

11. A method for shared web hosting, comprising:
verifying that a web page request is allowed access to information in a web site;
transmitting the web page request to a plurality of web servers and a control means after verification;
performing a lookup of a data structure means to determine identification information for the web page request, wherein the identification information includes website configuration information and virtual host information; and
routing the web page request to one or more of the web servers.

12. The method of claim 11, wherein the step of verifying further comprises authenticating user identification information to determine web site access.

13. The method of claim 11, wherein verification is performed by a centralized authentication server (CAS).

14. The method of claim 13, wherein verification information is stored on computer means coupled to the CAS.

15. The method of claim 11, wherein the control means is a shared table controller.

16. The method of claim 11, wherein the data structure means is a shared table.

17. A system for shared web hosting, comprising:
at least two of a first computer means coupled to a second computer means, wherein the first computer means each couple to a storage device that includes web site configuration and virtual host information;
a third computer means coupled to each of the first computer means, wherein the third computer means transmits web page requests to the second computer means; and
wherein the second computer means periodically update configuration and virtual host information on all the first computer means to maintain coherency.

18. The system of claim 17, wherein the first computer means is a web server.

19. The system of claim 17, wherein the second computer means is a synchronization server.

20. The system of claim 17, wherein the third computer means is a security server.
